(19) United States
(12) Patent Application Publication
(10) Pub. No.: US 2024/0149358 A1
(43) Pub. Date: May 9, 2024

(54) DRILL BIT

(71) Applicant: MILWAUKEE ELECTRIC TOOL CORPORATION, Brookfield, WI (US)

(72) Inventors: Brian R. Simpson, Milwaukee, WI (US); Travis J. DuMez, Port Washington, WI (US)

(21) Appl. No.: 18/503,532

(22) Filed: Nov. 7, 2023

Related U.S. Application Data
(60) Provisional application No. 63/382,619, filed on Nov. 7, 2022.

(51) Int. Cl. B23B 51/02

(52) U.S. Cl. CPC B23B 51/02; B23B 2251/4012; B23B 2251/406

(57) ABSTRACT

A drill bit including a body, a shank, a cutting head, and an external covering. The body has a first end and a second end. The shank is located at the first end. The cutting head is located at the second end. The external covering is separately formed from the body and is located between the first end and the second end of the body. The external covering includes a sleeve. The sleeve has a sleeve body that radially surrounds a portion of the body and a plurality of flutes helically wrapped around the sleeve body.

### CROSS-REFERENCE TO RELATED APPLICATIONS

This application claims priority to U.S. Provisional Patent Application No. 63/382,619 filed on Nov. 7, 2022, the entire contents of which are incorporated herein by reference.

### FIELD OF THE INVENTION

The present invention relates to power tool accessories. More specifically, the present invention relates to drill bits.

### BACKGROUND

Drill bits, such as masonry drill bits, are used to drill holes into hard materials such as concrete, stone, brick, tile and the like. Some drill bits can be used with power tools such as rotary hammers that are operable in a drilling mode which only rotates the masonry drill, a chisel mode which delivers only percussive force to the masonry drill, or a hammer drill mode which rotationally drives the masonry drill and delivers a percussive force to the masonry drill.

### SUMMARY

In one aspect, the disclosure provides a drill bit including a body, a shank, a cutting head, and an external covering. The body has a first end and a second end. The shank is located at the first end. The cutting head is located at the second end. The external covering is separately formed from the body and is located between the first end and the second end of the body. The external covering includes a sleeve. The sleeve has a sleeve body that radially surrounds a portion of the body and a plurality of flutes helically wrapped around the sleeve body.

In another aspect, the disclosure provides a drill bit including a body, a shank, a cutting head, and a plurality of flutes. The body has a first end and a second end. The body is formed of a first material. The shank is located at the first end and is configured to receive energy from a tool. The shank is formed of the first material. The cutting head is located at the second end. The cutting head is at least partially formed of the first material. The plurality of flutes is located between the shank and the cutting head. The plurality of flutes is formed of a second material.

In another aspect, the disclosure provides a method for manufacturing a drill bit. The method includes forming a body, a shank, and a cutting head of a first material, forming a sleeve of a second material that is different than the first material, and affixing the sleeve to the body. The body has a first end and a second end. The shank is located at the first end. The cutting head is located at the second end. The sleeve includes a sleeve body and a plurality of flutes helically wrapped around the sleeve body. The sleeve is affixed to the body at a position between the first end and the second end of the body such that the sleeve body radially surrounds a portion of the body.

Other aspects of the invention will become apparent by consideration of the detailed description and accompanying drawings.

### BRIEF DESCRIPTION OF THE DRAWINGS

FIG. 1 is a perspective view of a drill bit including a shank, a body, a cutting head, and an external covering according to an embodiment of the disclosure.

FIG. 2 is an exploded view of the drill bit.

FIG. 3 is an enlarged view of the cutting head.

FIG. 4 is a perspective view of the external covering including a sleeve and a flute covering.

FIG. 5 is a perspective view of the sleeve.

FIG. 6 is a side view of the body, the cutting head, and the sleeve.

FIG. 7 is a perspective view of the flute covering.

FIG. 8 is a flowchart depicting a method of manufacturing the drill bit.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

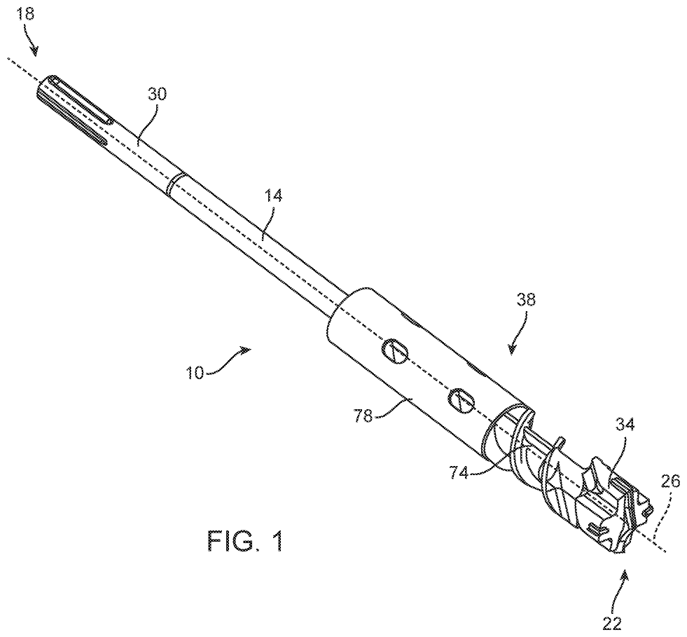

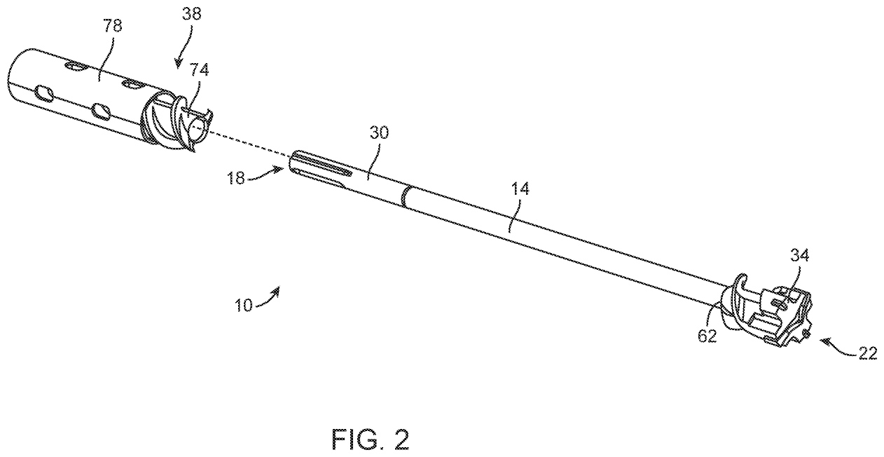

FIGS. 1 and 2 illustrate a drill bit 10. The drill bit 10 includes a body 14 having a first end 18, a second end 22 opposite the first end 18, and an axis of rotation 26. The axis of rotation 26 extends through the first end 18 and the second end 22. The drill bit 10 further includes a shank 30, a cutting head 34, and an external covering 38. The shank 30 is located at the first end 18 and is configured to be coupled to a power tool, such as a rotary tool. The illustrated shank 30 is an SDS-style shank, such as an SDS shank, an SDS Plus shank, or an SDS Max shank. In other embodiments, the shank 30 may have other configurations. The cutting head 34 is located at the second end 22 and is configured to engage a work piece, such as, for example, concrete. In the illustrated embodiment, the body 14, the shank 30, and the cutting head 34 are integrally formed. In other embodiments, the body 14, the shank 30, and the cutting head 34 may be separately formed and fixed to each other. The external covering 38 is positioned on the body 14 between the first end 18 and the second end 22. In the illustrated embodiment, the external covering 38 is positioned relatively closer to the second end 22 of the body 14 than the first end 18 of the body 14.

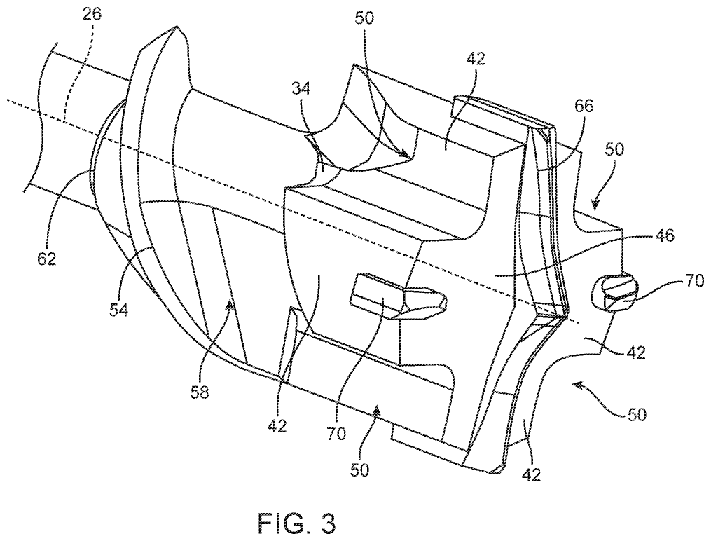

As illustrated in FIG. 3, the cutting head 34 includes a plurality of axial head lands 42 that extend from a tip 46 of the cutting head 34 and a plurality of axial head flutes 50 defined between plurality of axial head lands 42. More specifically, the cutting head 34 includes four axial head lands 42 spaced equally around a periphery of the cutting head 34. In other embodiments, the cutting head 34 may have fewer or more lands 42 and/or the lands 42 may be unequally spaced. In the illustrated embodiment, the axial head lands 42 and the axial head flutes 50 extend parallel to the axis of rotation 26 of the drill bit 10. In other embodiments, the axial head lands 42 and the axial head flutes 50 may be helically wrapped around the axis of rotation 26. The cutting head 34 further includes a plurality of helical head lands 54 that extends from the plurality of axial head lands 42 and a plurality of helical head flutes 58 defined between the plurality of helical head lands 54. More specifically, the cutting head 34 includes two helical head lands 54. In other embodiments, the cutting head 34 may include more than two helical head lands 54. Each helical head land 54 extends from a corresponding one of the axial head lands 42 to a step 62. At the step 62, the diameter of the drill bit 10 reduces from the cutting head 34 to the body 14 of the drill bit 10.

The cutting head 34 is shaped to receive one or more cutting inserts. For example, the illustrated cutting head 34 receives a primary cutting insert 66 and secondary cutting inserts 70. The cutting inserts 34 may be made of a relatively harder material than the rest of the cutting head 34, such as carbide. When assembled, the primary cutting insert 66 extends from one of the axial head lands 42 to another of the axial head lands 42 diametrically across tip 46 of the cutting head 34. In the illustrated embodiment, the two helical head lands 54 extend from a corresponding one of the axial head lands 42 that the primary cutting insert 66 extends across. The secondary cutting inserts 70 include two secondary cutting inserts 70. The secondary cutting inserts 70 are received in axial head lands 42 on opposite sides of the primary cutting insert 66. In other embodiments, the cutting head 34 may receive other types, shapes, or configurations of cutting inserts.

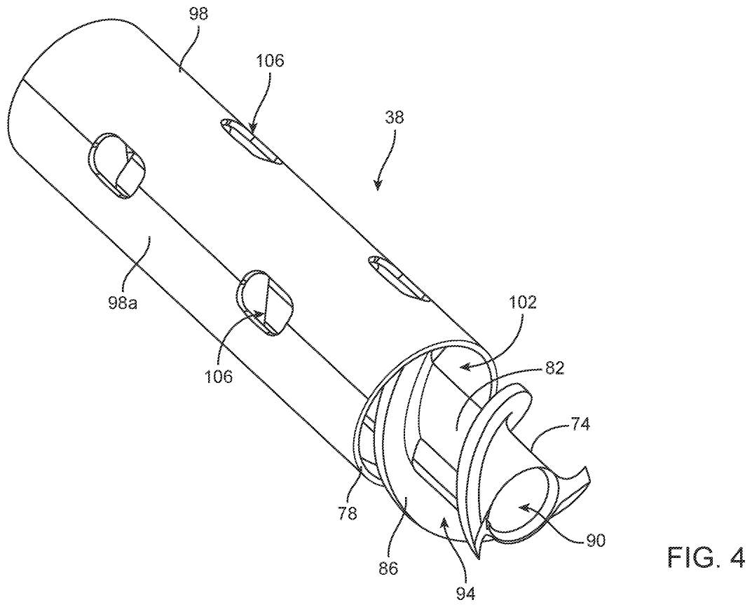

FIG. 4 illustrates the external covering 38. The external covering 38 is installable on the body 14 of the drill bit 10 (e.g., as illustrated in FIG. 2). The external covering 38 includes a sleeve 74 and a flute covering 78. Once assembled, with reference to FIGS. 1 and 4, the external covering 38 is inhibited from moving relative to the body 14 of the drill bit 10. For example, in some embodiments, the external covering 38 may be provided with an adhesive (e.g., epoxy) for securing the external covering 38 on the body 14 of the drill bit 10. Alternatively, in other embodiments, the external covering 38 may be brazed, welded, or press-fit to the body 14 of the drill bit 10. In further embodiments, the external covering 38 may be secured to the body 14 of the drill bit 10 by any other means that inhibits the external covering 38 from moving relative to the body 14 of the drill bit 10. As such, the external covering 38 is axially and rotationally fixed with the drill bit 10 such that the sleeve 74, the flute covering 78, and the body 14 of the drill bit 10 are all configured to rotate together during operation of the drill bit 10.

In yet further embodiments, the external covering 38 may not be axially and rotationally fixed with the body 14 of the drill bit 10. That is, the external covering 38 may be slightly movable relative to the body 14 of the drill bit 10 during operation of the drill bit 10. As such, the relative movement of the external covering 38 reduces energy lost during operation of the drill bit 10. When the external covering 38 is fixed relative to the body 14, the external covering 38 absorbs impact energy at the fixed point of the external covering 38. When the external covering 38 is not fixed to the body 14, the external covering 38 is enabled to move relative to the body 14 such that the external covering 38 does not absorb the impact energy, and therefore, reduces the energy lost during operation of the drill bit 10.

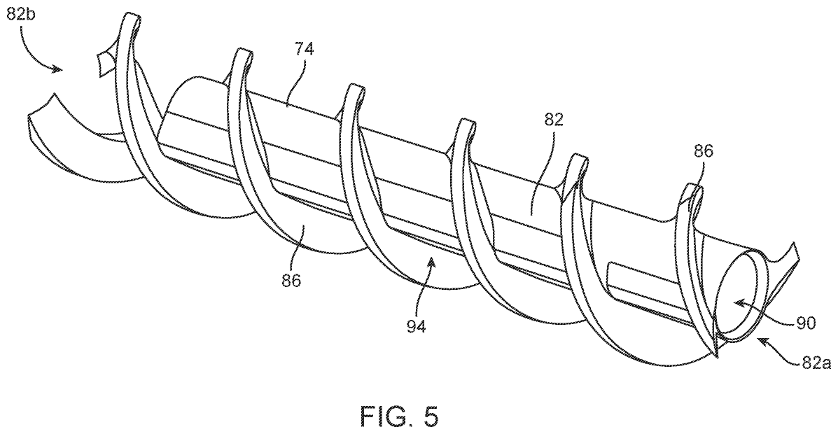

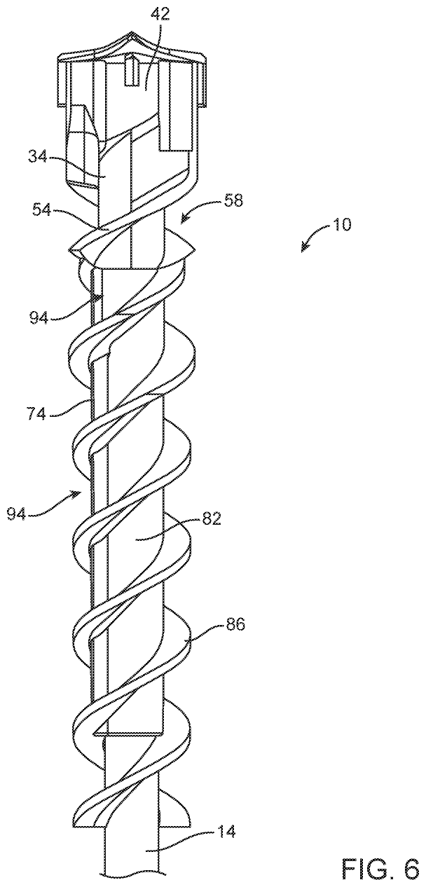

As illustrated in FIGS. 5 and 6, the sleeve 74 includes a sleeve body 82 and a plurality of sleeve lands 86 helically wrapped around the sleeve body 82. The sleeve body 82 defines a sleeve aperture 90 extending through the sleeve 74. The sleeve aperture 90 is shaped to receive the body 14 of the drill bit 10. In other words, when the drill bit 10 is assembled, the sleeve body 82 radially surrounds a portion of the body 14 of the drill bit 10. The plurality of sleeve lands 86 defines a plurality of sleeve flutes 94. As such, when the drill bit 10 is assembled, the sleeve flutes 94 at a first or forward end 82a of the sleeve body 82 are provided at the step 62 (e.g., as illustrated in FIG. 3) of the drill bit 10 between the body 14 and the cutting head 34 such that the sleeve flutes 94 align with the helical head flutes 58 to form continuous flutes for the drill bit 10. In other words, the first end 82a of the sleeve body 82 abuts the cutting head 34 when the drill bit 10 is assembled. The sleeve lands 86 of the sleeve body 82 extend from the step 62 (FIG. 3) past a second or rearward end 82b of the sleeve body 82 and toward the shank 30 (FIG. 1). As such, a portion of each of the plurality of sleeve flutes 94 is defined by the body 14 and the portion of the sleeve lands 86 that extends past the second end 82b of the sleeve body 82.

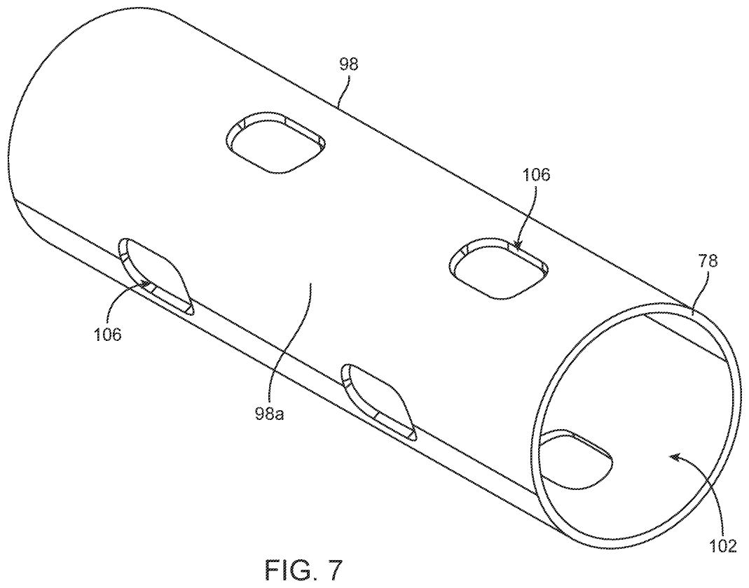

Turning reference to FIG. 7, the flute covering 78 includes a covering body 98. The covering body 98 is a generally solid, cylindrical member that defines a covering aperture 102 and a plurality of chip apertures 106. With reference to FIGS. 1 and 7, the covering aperture 102 is shaped and sized to simultaneously receive the body 14 of the drill bit 10 and the sleeve 74. In other words, when the drill bit 10 is assembled, the flute covering 78 radially surrounds a portion of the body 14 of the drill bit 10 and a portion of the sleeve 74. The plurality of chip apertures 106 is defined in an outer surface 98a of the covering body 98 and is in fluid communication with the covering aperture 102. As such, the plurality of chip apertures 106 enables cutting chip and other material evacuation from the sleeve flutes 94 during operation of the drill bit 10. That is, debris from a drilling operation that enters the covering aperture 102 may be removed through the plurality of chip apertures 106. The flute covering 78 has an outer diameter that is equal to or less than an outer diameter of the cutting head 34. More particularly, the illustrated flute covering 78 has an outer diameter that is generally equal to an outer diameter defined by the helical lands 54 (FIG. 6) of the cutting head 34.

Returning reference to FIG. 1, in the illustrated embodiment, the body 14, the shank 30, and the cutting head 34 of the drill bit 10 are formed of a first material, the sleeve 74 is formed of a second material, and the flute covering 78 is formed of a third material. The first material is a metal such as steel or another similar metal. In some embodiments, the primary cutting insert 66 and the secondary cutting inserts 70 may be formed of the first material. In other embodiments, the primary cutting insert 66 and the secondary cutting inserts 70 may be formed of a different metal than the first material, such as carbide or high-speed steel. As such, the primary cutting insert 66 and the secondary cutting inserts 70 may be formed of a fourth material. The second material may be a non-metal material such as a plastic. Alternatively, the second material may be another non-metal material such as a composite, a ceramic, or another similar non-material. In some embodiments, the third material may be the same material as the first material. In other embodiments, the third material may be a different metal than the first material. In further embodiments, the third material may be the same material as the second material. In still further embodiments, the third material may be a different non-metal material than the second material.

During operation of the drill bit 10, with reference to FIGS. 1 and 4, the external covering 38 advantageously increases drilling speed and the lifespan of the drill bit 10. As a power tool drives the drill bit 10, energy is transferred from the power tool to the shank 30 at the first end 18 of the drill bit 10. The drill bit 10 transfers the energy at the shank 30 to the cutting head 34 at the second end 22 of the drill bit 10 and onto a workpiece such as, for example, a concrete surface. By providing the sleeve lands 86 and the sleeve flutes 94 separately and forming the sleeve lands 86 of a different material from the body 14, the shank 30, and the cutting head 34, the drill bit 10 is enabled to transfer energy between the first end 18 and the second end 22 of the body 14 more efficiently. Specifically, the second material of the sleeve 74 is not conducive to energy transfer with the first material of the body 14 of the drill bit 10. As such, as energy is transferred between the first end 18 and the second end 22 of the body 14, the energy does not travel through the plurality of sleeve lands 86 and the plurality of sleeve flutes 94. Therefore, the energy is enabled to travel a more direct route, and thus a more efficient route, between the first end 18 and the second end 22. Additionally, the plurality of sleeve lands 86 and the plurality of sleeve flutes 94 have an increased lifespan over typical drill bits. Specifically, the removal of energy transfer from the power tool through the plurality of sleeve lands 86 and the plurality of sleeve flutes 94 reduces the stress and risk of fracture for the plurality of sleeve lands 86 and the plurality of sleeve flutes 94. The flute covering 78 helps protect the sleeve lands 86, particularly when the sleeve lands 86 are made of a non-metal material (e.g., plastic).

The external covering 38 beneficially enables a more efficient manufacturing process for the drill bit 10. Specifically, the time taken to manufacture the drill bit 10 and the amount of manufacturing waste generated from machining flutes into the body 14 of the drill bit 10 is reduced by providing the external covering 38 rather than forming flutes directly with the body 14. Additionally, the external covering 38 may expand the design space for flute and steel geometry near the cutting inserts 66, 70. That is, the external covering 38 does not require the cutting head 34 to directly align or connect to flutes formed in the body 14. Therefore, the cutting head 34 is not restricted by the body 14 and enables increased design space to design the drill bit 10 for varying applications.

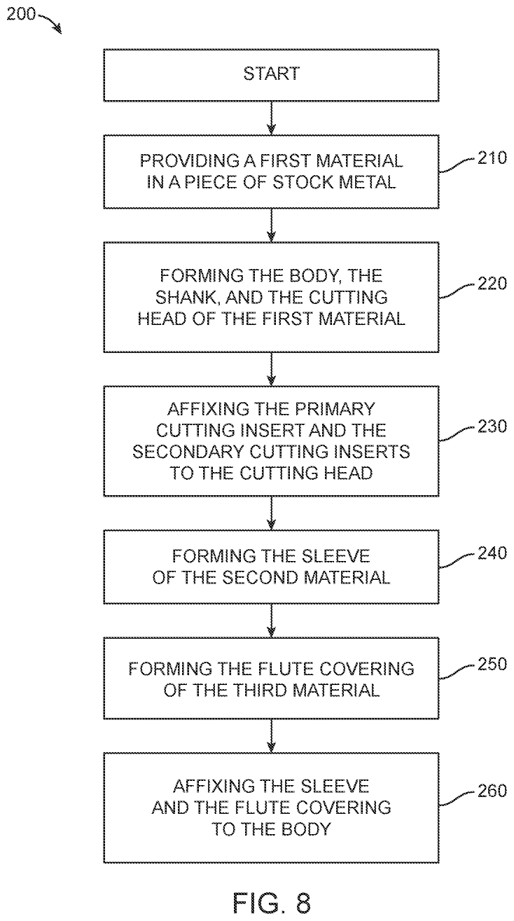

FIG. 8 illustrates a process 200 of manufacturing the drill bit 10. With reference to FIGS. 1 and 8, the process 200 begins at step 210 where the first material (e.g., steel) is provided in a piece of stock metal. At step 220, the body 14, the shank 30, and the cutting head 34 are formed of the first material in the piece of stock metal. The body 114, the shank 30, and the cutting head 34 may be formed from a variety of manufacturing methods such as, but not limited to, machining, molding, and the like. In some embodiments, the body 14, the shank 30, and the cutting head 34 may each be formed separately and then welded, or brazed, together. In further embodiments, the body 14, the shank 30, and the cutting head 34 may optionally undergo a heat treatment process before and/or after being formed. At step 230, the primary cutting insert 66 and the secondary cutting inserts 70 are affixed to the cutting head 34. The primary cutting insert 66 and the secondary cutting inserts 70 may be fixed to the cutting head 34 through any fixing means such as, but not limited to, welding, brazing, adhering, and the like.

At step 240, the sleeve 74 is formed from the second material. The sleeve 74 may be formed through a variety of plastic forming methods such as, but not limited to, injection molding. At step 250, the flute covering 78 is formed from the third material. In embodiments in which the flute covering 78 is a metal, the flute covering 78 may be formed from a variety of manufacturing methods such as, but not limited to, machining, molding, and the like. In embodiments, in which the flute covering 78 is a non-metal, the flute covering 78 may be formed from a variety of plastic forming methods such as, but not limited to injection molding. At step 260, the sleeve 74 and the flute covering 78 are affixed to the body 14 such that the sleeve 74 and the flute covering 78 are inhibited from moving relative to the body 14 of the drill bit 10. The sleeve 74 and the flute covering 78 may be affixed to the body 14 through any fixing means such as, but not limited to welding, brazing, adhering, and the like. In some embodiments, the sleeve 74 and the flute covering 78 may be simultaneously affixed to the body 14. In other embodiments, the sleeve 74 and the flute covering 78 may be affixed independently from each other. In further embodiments, the sleeve 74 and the flute covering 78 may be formed as a monolithic body. Affixing the sleeve 74 and the flute covering 78 to the body 14 includes affixing the sleeve 74 such that each of the helical head lands 54 is helically aligned with a corresponding one of the sleeve lands 86.

In some embodiments, the manufacturing process 200 may not include all of the steps described above or may include additional steps. In addition, the steps may be performed in other orders.

Although the invention is described with reference to discrete embodiments of the drill bit 10, variations of the drill bit 10 exist within the spirit and scope of the invention. Various features and advantages of the invention are set forth in the following claims.

What is claimed is:

1. A drill bit comprising:
a body having a first end and a second end;
a shank located at the first end;
a cutting head located at the second end; and
an external covering separately formed from the body and located between the first end and the second end of the body, the external covering including
a sleeve having a sleeve body that radially surrounds a portion of the body and a plurality of flutes helically wrapped around the sleeve body.

2. The drill bit of claim 1, wherein the external covering further includes a flute covering that radially surrounds the body and the plurality of flutes.

3. The drill bit of claim 2, wherein the flute covering includes a plurality of apertures defined in an outer surface of the flute covering.

4. The drill bit of claim 1, wherein the cutting head includes a plurality of helical head flutes that align with the plurality of flutes of the sleeve.

5. The drill bit of claim 4, wherein the cutting head includes a plurality of axial head flutes that extend from ends of the plurality of helical head flutes opposite from the external cover, and wherein the plurality of axial head flutes extend in a direction parallel to an axis extending through the first end and the second end of the body.

6. The drill bit of claim 1, wherein the external covering is rotationally affixed to the body.

7. The drill bit of claim 1, wherein a forward end of the sleeve body is positioned adjacent the second end of the body.

8. The drill bit of claim 6, wherein the sleeve includes a plurality of sleeve lands that define the plurality of flutes, and wherein the plurality of sleeve lands extends from the forward end of the sleeve body past a rearward end of the sleeve body.

9. The drill bit of claim 1, wherein the sleeve includes a plurality of sleeve lands that partially define the plurality of flutes, and wherein the plurality of flutes is also partially defined by the body of the drill bit and partially defined by the sleeve body.

10. A drill bit comprising:
a body having a first end and a second end, the body formed of a first material;
a shank located at the first end and configured to receive energy from a tool, the shank formed of the first material;
a cutting head located at the second end, the cutting head at least partially formed of the first material; and
a plurality of flutes located between the shank and the cutting head, the plurality of flutes formed of a second material that is different than the first material.

11. The drill bit of claim 10, wherein the cutting head includes a plurality of head flutes that is formed of the first material.

12. The drill bit of claim 11, wherein each of the plurality of head flutes is helically aligned with a corresponding one of the plurality of flutes.

13. The drill bit of claim 10, further comprising a flute covering that surrounds the plurality of flutes, the flute covering formed of a third material.

14. The drill bit of claim 13, wherein the third material is the same as the first material or the second material.

15. The drill bit of claim 13, wherein the cutting head includes a plurality of cutting inserts, and wherein the plurality of cutting inserts is formed of a fourth material.

16. The drill bit of claim 10, wherein the plurality of flutes is rotationally affixed to the body.

17. A method of manufacturing a drill bit, the method comprising:
forming a body, a shank, and a cutting head of a first material, the body having a first end and a second end, the shank located at the first end, and the cutting head located at the second end;
forming a sleeve of a second material that is different than the first material, the sleeve including a sleeve body and a plurality of flutes helically wrapped around the sleeve body; and
affixing the sleeve to the body at a position between the first end and the second end of the body such that the sleeve body radially surrounds a portion of the body.

18. The method of claim 17, further comprising forming a flute covering of a third material, and affixing the flute covering to the sleeve such that the flute covering at least partially surrounds the plurality of flutes.

19. The method of claim 18, wherein the third material is the same as the first material or the second material.

20. The method of claim 17, wherein forming the body, the shank, and the cutting head includes forming the cutting head with a plurality of helical head flutes, and wherein affixing the sleeve to the body includes affixing the sleeve such that each of the plurality of helical head flutes is helically aligned with a corresponding one of the plurality of flutes.
